(19) United States
(12) Patent Application Publication
(10) Pub. No.: US 2025/0232683 A1
(43) Pub. Date: Jul. 17, 2025

(54) SYSTEMS AND METHODS FOR PROVIDING INTERACTIVE EMERGENCY LANDING ASSISTANCE

(71) Applicant: HONEYWELL INTERNATIONAL INC., Charlotte, NC (US)

(72) Inventors: Naveen Venkatesh Prasad Nama, Bangalore (IN); Vineetha Chandran, Bangalore (IN); Madhusudhan Chikkachanne Gowda, Bangalore (IN); Anbazhagan Palanichamy, Bangalore (IN)

(73) Assignee: HONEYWELL INTERNATIONAL INC., Charlotte, NC (US)

(21) Appl. No.: 18/594,289

(22) Filed: Mar. 4, 2024

(30) Foreign Application Priority Data
Jan. 16, 2024 (IN) 202411003060

(51) Int. Cl. G08G 5/02; G08G 5/00

(52) U.S. Cl. CPC G08G 5/54; G08G 5/55; G08G 5/58

(57) ABSTRACT

Systems and methods are provided for providing interactive emergency landing assistance. Receiving a pilot incapacitation indication. Receiving aircraft state data from at least one avionics system of an aircraft. Transmitting an emergency landing assistance request and the aircraft state data to the ground station. Receiving a first landing instruction based on the aircraft state data from the ground station. Determining whether a pre-defined period of time has elapsed without implementation of the first landing instruction. Generating instruction details associated with the implementation of the first landing instruction based on the determination. Receiving updated aircraft state data from the at least one avionics system following the implementation of the first landing instruction. Transmitting the updated aircraft state data to the ground station. Receiving a second landing instruction based on the updated aircraft state data from the ground station.

### CROSS-REFERENCE TO RELATED APPLICATION

This application claims priority to India Provisional Patent Application No. 202411003060, filed Jan. 16, 2024, the entire content of which is incorporated by reference herein.

### TECHNICAL FIELD

The present invention generally relates to aircraft operations and more particularly relates to systems and methods for providing interactive emergency landing assistance.

### BACKGROUND

In emergency situations, where a single pilot of an aircraft becomes incapacitated and is unable to fly an aircraft, a crew member or a passenger with minimum or no flying experience may have to assume responsibility for safely landing the aircraft. A series of landing instructions are typically followed to implement the appropriate aircraft control functions to land the aircraft. Each landing instruction may include a sequence of landing instruction steps that involves one or more aircraft control mechanisms. Examples of aircraft control mechanisms include, but are not limited to, aircraft guidance panels, aircraft throttle controls, aircraft flap controls, aircraft gear controls, aircraft trim controls, and aircraft spoiler controls. It may be challenging for an individual with limited or no flying experience to identify the appropriate aircraft control mechanisms to engage to implement the landing instructions. In many cases, lack of feedback regarding whether the landing instructions were properly implemented may lead to an increased risk of an adverse aircraft incident.

Hence, there is a need for systems and methods for providing interactive emergency landing assistance in an aircraft.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various embodiments, a method of providing interactive emergency landing assistance includes: receiving a pilot incapacitation indication at an interactive emergency landing assistance system; receiving aircraft state data from at least one avionics system of an aircraft at the interactive emergency landing assistance system; transmitting an emergency landing assistance request and the aircraft state data from the interactive emergency landing assistance system to a ground station; receiving a first landing instruction from the ground station at the interactive emergency landing assistance system, the first landing instruction being based on the aircraft state data; determining, by the interactive emergency landing assistance system, whether a first pre-defined period of time has elapsed following receipt of the first landing instruction without implementation of the first landing instruction; generating, by the interactive emergency landing assistance system, instruction details associated with the implementation of the first landing instruction; receiving updated aircraft state data from the at least one avionics system at the interactive emergency landing assistance system following the implementation of the first landing instruction; transmitting the updated aircraft state data from the interactive emergency landing assistance system to the ground station; and receiving a second landing instruction from the ground station at the interactive emergency landing assistance system, the second landing instruction being based on the updated aircraft state data.

In various embodiments, a non-transitory machine-readable storage medium that stores instructions executable by at least one processor, the instructions configurable to cause the at least one processor to perform operations including: receiving a pilot incapacitation indication at an interactive emergency landing assistance system; receiving aircraft state data from at least one avionics system of an aircraft at the interactive emergency landing assistance system; transmitting an emergency landing assistance request and the aircraft state data from the interactive emergency landing assistance system to a ground station; receiving a first landing instruction from the ground station at the interactive emergency landing assistance system, the first landing instruction being based on the aircraft state data; determining, by the interactive emergency landing assistance system, whether a first pre-defined period of time has elapsed following receipt of the first landing instruction without implementation of the first landing instruction; generating, by the interactive emergency landing assistance system, instruction details associated with the implementation of the first landing instruction; receiving updated aircraft state data from the at least one avionics system at the interactive emergency landing assistance system following the implementation of the first landing instruction; transmitting the updated aircraft state data from the interactive emergency landing assistance system to the ground station; and receiving a second landing instruction from the ground station at the interactive emergency landing assistance system, the second landing instruction being based on the updated aircraft state data.

Furthermore, other desirable features and characteristics of the systems and methods for providing interactive emergency landing assistance become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a block diagram representation of a system configured implement providing interactive emergency landing assistance in accordance with least one embodiment;

FIG. 2 is a block diagram representation of an aircraft including an interactive emergency landing assistance system in accordance with at least one embodiment;

FIG. 3 is a block diagram representation of an open world computer (OWC) including an interactive emergency landing assistance system in accordance with at least one embodiment;

FIG. 4 is a flowchart representation of a method of providing interactive emergency landing assistance in accordance with at least one embodiment; and

FIG. 5A-5C are diagrammatic representations of exemplary graphical landing instruction steps associated with a landing instruction in accordance with at least one embodiment.

### DETAILED DESCRIPTION

The following detailed description is merely exemplary in nature. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

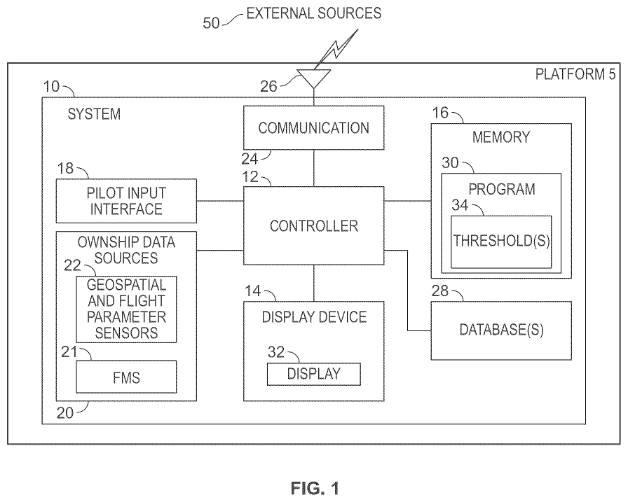

FIG. 1 is a block diagram representation of a system 10 configured implement providing interactive emergency landing assistance in accordance with least one embodiment (shortened herein to “system” 10), as illustrated in accordance with an exemplary and non-limiting embodiment of the present disclosure. The system 10 may be utilized onboard a mobile platform 5, as described herein. In various embodiments, the mobile platform is an aircraft, which carries or is equipped with the system 10. As schematically depicted in FIG. 1, the system 10 includes the following components or subsystems, each of which may assume the form of a single device or multiple interconnected devices: a controller circuit 12 operationally coupled to: at least one display device 14; computer-readable storage media or memory 16; an optional input interface 18, and ownship data sources 20 including, for example, a flight management system (FMS) 21 and an array of flight system state and geospatial sensors 22.

In various embodiments, the system 10 may be separate from or integrated within: the flight management system (FMS) 21 and/or a flight control system (FCS). Although schematically illustrated in FIG. 1 as a single unit, the individual elements and components of the system 10 can be implemented in a distributed manner utilizing any practical number of physically distinct and operatively interconnected pieces of hardware or equipment. When the system 10 is utilized as described herein, the various components of the system 10 will typically all be located onboard the mobile platform 5.

The term “controller circuit” (and its simplification, “controller”), broadly encompasses those components utilized to carry-out or otherwise support the processing functionalities of the system 10. Accordingly, the controller circuit 12 can encompass or may be associated with a programmable logic array, application specific integrated circuit or other similar firmware, as well as any number of individual processors, flight control computers, navigational equipment pieces, computer-readable memories (including or in addition to the memory 16), power supplies, storage devices, interface cards, and other standardized components. In various embodiments, the controller circuit 12 embodies one or more processors operationally coupled to data storage having stored therein at least one firmware or software program (generally, computer-readable instructions that embody an algorithm) for carrying-out the various process tasks, calculations, and control/display functions described herein. During operation, the controller circuit 12 may be programmed with and execute the at least one firmware or software program, for example, a program 30, that embodies an algorithm described herein for providing interactive emergency landing assistance in accordance with least one embodiment on a mobile platform 5, where the mobile platform 5 is an aircraft, and to accordingly perform the various process steps, tasks, calculations, and control/display functions described herein.

The controller circuit 12 may exchange data, including real-time wireless data, with one or more external sources 50 to support operation of the system 10 in embodiments. In this case, bidirectional wireless data exchange may occur over a communications network, such as a public or private network implemented in accordance with Transmission Control Protocol/Internet Protocol architectures or other conventional protocol standards. Encryption and mutual authentication techniques may be applied, as appropriate, to ensure data security.

The memory 16 is a data storage that can encompass any number and type of storage media suitable for storing computer-readable code or instructions, such as the aforementioned software program 30, as well as other data generally supporting the operation of the system 10. The memory 16 may also store one or more threshold 34 values, for use by an algorithm embodied in software program 30. One or more database(s) 28 are another form of storage media; they may be integrated with memory 16 or separate from it.

In various embodiments, aircraft-specific parameters and information for an aircraft may be stored in the memory 16 or in a database 28 and referenced by the program 30. Non-limiting examples of aircraft-specific information includes an aircraft weight and dimensions, performance capabilities, configuration options, and the like.

Flight parameter sensors and geospatial sensors 22 supply various types of data or measurements to the controller circuit 12 during an aircraft flight. In various embodiments, the geospatial sensors 22 supply, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data.

With continued reference to FIG. 1, the display device 14 can include any number and type of image generating devices on which one or more avionic displays 32 may be produced. When the system 10 is utilized for a manned aircraft, the display device 14 may be affixed to the static structure of the Aircraft cockpit as, for example, a Head Down Display (HDD) or Head Up Display (HUD) unit. In various embodiments, the display device 14 may assume the form of a movable display device (e.g., a pilot-worn display device) or a portable display device, such as an Electronic Flight Bag (EFB), a laptop, or a tablet computer carried into the aircraft cockpit by a pilot.

At least one avionic display 32 is generated on the display device 14 during operation of the system 10; the term “avionic display” is synonymous with the term “aircraft-related display” and “cockpit display” and encompasses displays generated in textual, graphical, cartographical, and other formats. The system 10 can generate various types of lateral and vertical avionic displays 32 on which map views and symbology, text annunciations, and other graphics pertaining to flight planning are presented for a pilot to view. The display device 14 is configured to continuously render at least a lateral display showing the aircraft at its current location within the map data. The avionic display 32 generated and controlled by the system 10 can include graphical user interface (GUI) objects and alphanumerical input displays of the type commonly presented on the screens of multifunction control display units (MCDUs), as well as Control Display Units (CDUs) generally. Specifically, embodiments of the avionic displays 32 include one or more two-dimensional (2D) avionic displays, such as a horizontal (i.e., lateral) navigation display or vertical navigation display (i.e., vertical situation display VSD); and/or on one or more three dimensional (3D) avionic displays, such as a Primary Flight Display (PFD) or an exocentric 3D avionic display.

In various embodiments, a human-machine interface is implemented as an integration of a pilot input interface 18 and a display device 14. In various embodiments, the display device 14 is a touch screen display. In various embodiments, the human-machine interface also includes a separate pilot input interface 18 (such as a keyboard, cursor control device, voice input device, or the like), generally operationally coupled to the display device 14. Via various display and graphics systems processes, the controller circuit 12 may command and control a touch screen display device 14 to generate a variety of graphical user interface (GUI) objects or elements described herein, including, for example, buttons, sliders, and the like, which are used to prompt a user to interact with the human-machine interface to provide user input; and for the controller circuit 12 to activate respective functions and provide user feedback, responsive to received user input at the GUI element.

In various embodiments, the system 10 may also include a dedicated communications circuit 24 configured to provide a real-time bidirectional wired and/or wireless data exchange for the controller 12 to communicate with the external sources 50 (including, each of: traffic, air traffic control (ATC), satellite weather sources, ground stations, and the like). In various embodiments, the communications circuit 24 may include a public or private network implemented in accordance with Transmission Control Protocol/Internet Protocol architectures and/or other conventional protocol standards. Encryption and mutual authentication techniques may be applied, as appropriate, to ensure data security. In some embodiments, the communications circuit 24 is integrated within the controller circuit 12, and in other embodiments, the communications circuit 24 is external to the controller circuit 12. When the external source 50 is “traffic,” the communications circuit 24 may incorporate software and/or hardware for communication protocols as needed for traffic collision avoidance (TCAS), automatic dependent surveillance-broadcast (ADS-B), and enhanced vision systems (EVS).

In certain embodiments of the system 10, the controller circuit 12 and the other components of the system 10 may be integrated within or cooperate with any number and type of systems commonly deployed onboard an aircraft including, for example, an FMS 21.

The disclosed algorithm is embodied in a hardware program or software program (e.g. program 30 in controller circuit 12) and configured to operate when the aircraft is in any phase of flight.

In various embodiments, the provided controller circuit 12, and therefore its program 30 may incorporate the programming instructions for: receiving a pilot incapacitation indication at an interactive emergency landing assistance system; receiving aircraft state data from at least one avionics system of an aircraft at the interactive emergency landing assistance system; transmitting an emergency landing assistance request and the aircraft state data from the interactive emergency landing assistance system to a ground station; receiving a first landing instruction from the ground station at the interactive emergency landing assistance system, the first landing instruction being based on the aircraft state data; determining, by the interactive emergency landing assistance system, whether a first pre-defined period of time has elapsed following receipt of the first landing instruction without implementation of the first landing instruction; generating, by the interactive emergency landing assistance system, instruction details associated with the implementation of the first landing instruction; receiving updated aircraft state data from the at least one avionics system at the interactive emergency landing assistance system following the implementation of the first landing instruction; transmitting the updated aircraft state data from the interactive emergency landing assistance system to the ground station; and receiving a second landing instruction from the ground station at the interactive emergency landing assistance system, the second landing instruction being based on the updated aircraft state data.

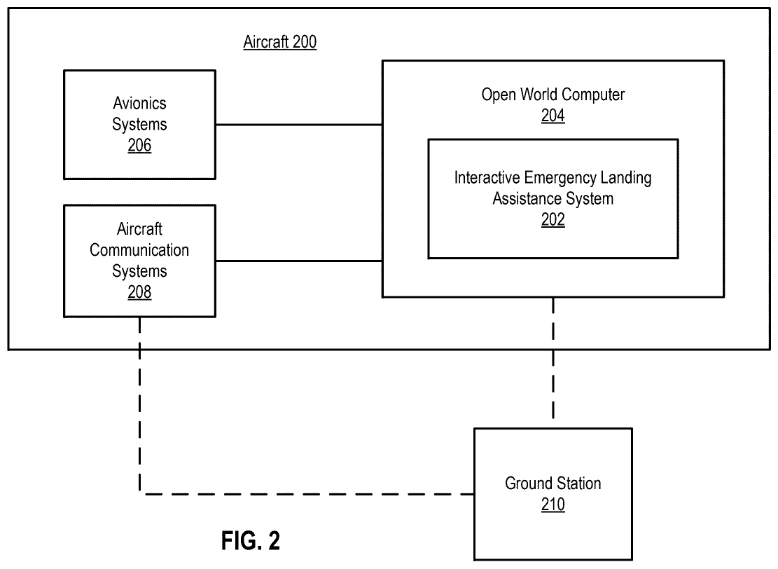

Referring to FIG. 2, a block diagram representation of an aircraft 200 including an interactive emergency landing assistance system 202 in accordance with at least one embodiment is shown. The aircraft 200 has a configuration similar to the mobile platform 5 in FIG. 1. The aircraft 200 includes an open world computer (OWC) 204, avionics systems 206, and an aircraft communication system 208. The OWC 204 is a portable computing device. Examples of OWC 204 include, but are not limited to, an electronic flight bag (EFB), a laptop, and a tablet computer. Examples of avionics systems 206 include, but are not limited to, flight control surfaces, flight management system, control panels, and geospatial sensors. Examples of flight control surfaces include, but are not limited to, flaps, spoilers, gears, and throttle. Examples of control panels include, but are not limited to, flight guidance panel, display controller, radio altimeter, and GPS. The aircraft communication system 208 is similar to the communications circuit 24 in FIG. 1.

The OWC 204 is configured to be communicatively coupled to one or more avionics systems 206 of the aircraft 200. In at least one embodiment, the OWC 204 is configured to be communicatively coupled to one or more avionics systems 206 of the aircraft 200 via a gateway. The interactive emergency landing assistance system 202 is configured to receive aircraft state data from the avionics systems 206. Examples of aircraft state data include, but are not limited to, flap detent, flap angle, calibrated airspeed, vertical speed, barometric altitude, current position, height above terrain, throttle level angle, gear state, and data detected by the geospatial sensors.

In at least one embodiment, the OWC 204 is configured to be communicatively coupled to a ground station 210. Communicative coupling between the interactive emergency landing assistance system 202 and the ground station 210 is established via the OWC 204. In at least one embodiment, the OWC 204 is configured to be communicatively coupled to the aircraft communication system 208. The OWC 204 is configured to be communicative coupled to the ground station 210 via the aircraft communication system 208. Communicative coupling between the interactive emergency landing assistance system 202 and the ground station 210 is established via the OWC 204 and the aircraft communication system 208. Examples of ground stations include, but are not limited to, air traffic control (ATC) and an airport operation center (AOC) service provider.

The availability of the interactive emergency landing assistance system 202 to assist a crew member or a passenger with minimum or no flying experience that may have to assume responsibility for safely landing the aircraft 200 in the event of pilot incapacitation may be presented during passenger briefing. The passenger briefing may include a demonstration on how to activate the interactive emergency landing assistance system 202.

While the OWC 204 has been described as including the interactive emergency landing assistance system 202, in alternative embodiments, the interactive emergency landing system 202 may be an integrated component of the aircraft 200.

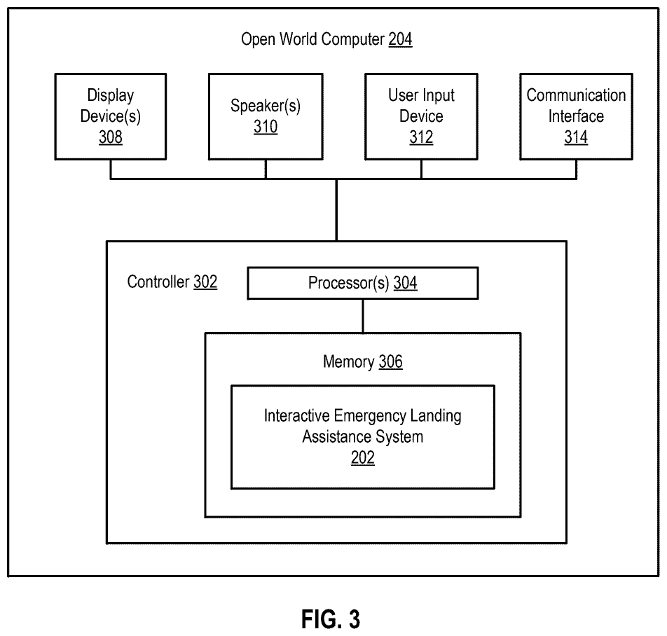

Referring to FIG. 3, a block diagram representation of an open world computer (OWC) 204 including an interactive emergency landing assistance system 202 in accordance with at least one embodiment is shown. The OWC 204 includes a controller 302. The controller 302 includes at least one processor 304 and at least one memory 306. The at least one memory 306 includes the interactive emergency landing assistance system 202. In various embodiments, the controller 302 may include additional components that facilitate operation of the controller 302.

The OWC 204 includes one or more display devices 308, at least one speaker 310, at least one user input device 312, and a communication interface 314. The interactive emergency landing assistance system 202 is configured to be communicatively coupled to the avionics systems 206, the aircraft communication system 208 and the ground station 210 via the communication interface 314. The OWC 204 may include additional components that facilitate operation of the OWC 204. The operation of the interactive emergency landing assistance system 202 will be described in further detail below.

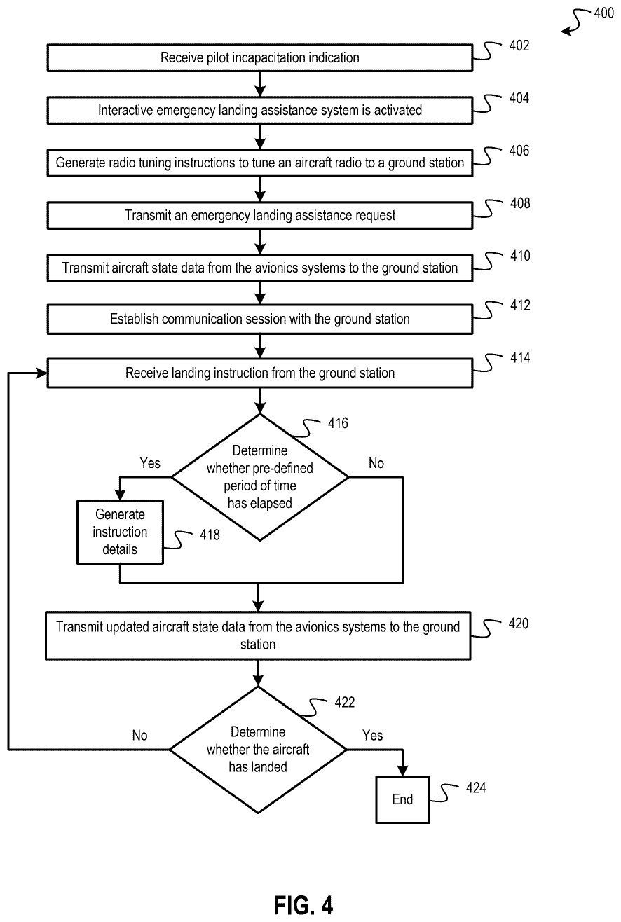

Referring to FIG. 4, a flowchart representation of a method 400 of providing interactive emergency landing assistance in accordance with at least one embodiment is shown. The method 400 will be described with reference to an exemplary implementation of an interactive emergency landing assistance 202. As can be appreciated in light of the disclosure, the order of operation within the method 400 is not limited to the sequential execution as illustrated in FIG. 4 but may be performed in one or more varying orders as applicable and in accordance with the present disclosure.

At 402, a pilot incapacitation indication is received at the interactive emergency landing assistance system 202. In at least one embodiment, the interactive emergency landing assistance system 202 receives the pilot incapacitation indication from a pilot state monitoring system. The pilot state monitoring system is configured to monitor the biometric data of the pilot. If the pilot state monitoring system detects biometric data that indicates that the pilot may be incapacitated, the pilot state monitoring system transmits a pilot incapacitation indication to the interactive emergency landing assistance system 202. The interactive emergency landing assistance system 202 receives the pilot incapacitation indication from the pilot state monitoring system via a communication interface 314 of an OWC 204. In at least one embodiment, the pilot state monitoring system is a wearable device that monitors pilot biometric data.

In at least one embodiment, the interactive emergency landing assistance system 202 receives the pilot incapacitation indication via user input. The interactive emergency landing assistance system 202 receives the user input via a user input device 312 of the OWC 204. A user may provide the pilot incapacitation indication user input to the interactive emergency landing assistance system 202 via the user input device 312. Examples of users include, but are not limited to, the pilot, a crewmember, and a passenger.

At 404, the interactive emergency landing assistance system 202 is activated. In various embodiments, the interactive emergency landing assistance system 202 generates an emergency landing assistance prompt for display on a display device 308 of the aircraft 200 responsive to receipt of the pilot incapacitation indication. The interactive emergency landing assistance system 202 is activated responsive to activation of the emergency landing assistance prompt via a user input received via a user input device 312. In various embodiments, the aircraft 200 includes an emergency landing assistance switch in the cockpit of the aircraft 200. The interactive emergency landing assistance system 202 is activated responsive to activation of the emergency landing assistance switch.

At 406, the interactive emergency landing assistance system 202 generates radio tuning instructions to tune an aircraft radio to a ground station 210. In at least one embodiment, the interactive emergency landing assistance system 202 generates the radio tuning instructions for transmission as audio radio tuning instructions for transmission via the speaker 310 of the OWC 204. In at least one embodiment, the interactive emergency landing assistance system 202 generates the radio tuning instructions for transmission as visual radio tuning instructions for display on a display device 308 of the OWC 204. The visual radio tuning instructions are presented using visual aids, such as for example pictures and/or videos.

In at least one embodiment, the interactive emergency landing assistance system 202 determines an aircraft type of the aircraft 200. The interactive emergency landing assistance system 202 identifies the nearest airport having a runway that is compatible with the aircraft type. The interactive emergency landing assistance system 202 generates radio tuning instructions to tune the aircraft radio to a ground station 210 of the identified nearest airport.

In at least one embodiment, the interactive emergency landing assistance system 202 determines an aircraft status of the aircraft 200. The interactive emergency landing assistance system 202 identifies the nearest airport having a runway that is compatible with the aircraft status. The interactive emergency landing assistance system 202 generates radio tuning instructions to tune the aircraft radio to a ground station 210 of the identified nearest airport.

In at least one embodiment, the interactive emergency landing assistance system 202 determines the aircraft type and the aircraft status of the aircraft 200. The interactive emergency landing assistance system 202 identifies the nearest airport having a runway that is compatible with the aircraft type and the aircraft status. The interactive emergency landing assistance system 202 generates radio tuning instructions to tune the aircraft radio to a ground station 210 of the identified nearest airport.

At 408, an emergency landing assistance request is transmitted to the ground station 210. In at least one embodiment, the interactive emergency landing assistance system 202 transmits the emergency landing assistance request to the ground station 210. In at least one embodiment, the interactive emergency landing assistance system 202 automatically transmits the emergency landing assistance request to the ground station 210 responsive to activation of the interactive emergency landing assistance system 202.

In at least one embodiment, the interactive emergency landing assistance system 202 generates user guidance phraseology associated with the emergency landing assistance request for transmission to an output device onboard the aircraft. In at least one embodiment, the interactive emergency landing assistance system 202 generates the user guidance phraseology associated with the emergency landing assistance request for display on the display device 308 of the OWC 204. In at least one embodiment, the user contacts the ground station 210 using the aircraft communication system 208 and uses the user guidance phraseology to vocally communicate the emergency landing assistance request to the ground station 210.

At 410, aircraft state data from the avionics systems 206 is transmitted to the ground station 210. In various embodiments, the interactive emergency landing assistance system 202 receives the aircraft state data from the avionics systems 206 and transmits the received the aircraft state data to the ground station 210. In various embodiments, the interactive emergency landing assistance system 202 initiates the transmission of the aircraft state data from the avionics systems 206 to the ground station 210 via the aircraft communication system 208. In at least one embodiment, the aircraft state data from the avionics systems 206 is transmitted to the ground station 210 on a continuous basis. In at least one embodiment, the aircraft state data from the avionics systems 206 is transmitted to the ground station 210 on a periodic basis. In at least one embodiment, the interactive emergency landing assistance system 202 transmits the aircraft state data to the ground station 210 via one of very high frequency (VHF) communication, satellite communication (SATCOM), and cellular communication.

At 412, a communication session is established between the interactive emergency landing assistance system 202 and the ground station 210. In at least one embodiment, the communication session is established between the interactive emergency landing assistance system 202 and the ground station 210 via the OWC 204. In at least one embodiment, the communication session is established between the interactive emergency landing assistance system 202 and the ground station 210 via the OWC 204 and the aircraft communication system 208.

Implementation of the emergency landing of the aircraft includes implementation of a series of landing instructions. Each landing instruction includes a sequence of landing instruction steps associated with implementation of an aircraft control function. At 414, the interactive emergency landing assistance system 202 receives a landing instruction from the ground station 210. The ground station 210 generates the landing instruction based on the aircraft state data and transmits the landing instruction to the interactive emergency landing assistance system 202. The landing instruction includes a sequence of landing instruction steps.

In at least one embodiment, the interactive emergency landing assistance system 202 receives the landing instruction from the ground station 210 as an audio landing instruction for transmission via the speaker 310 of the OWC 204. In at least one embodiment, the interactive emergency landing assistance system 202 receives the landing instruction from the ground station 210 as a graphical landing instruction for display on a display device 308 of the OWC 204. In at least one embodiment, the graphical landing instruction includes one or more pictures. Each picture is associated with a landing instruction step of the landing instruction. In at least one embodiment, the graphical landing instruction includes one or more videos. Each video is associated with a landing instruction step of the landing instruction. In at least one embodiment, the interactive emergency landing assistance system 202 receives the landing instruction from the ground station 210 as a combination of an audio landing instruction for transmission via the speaker 310 and a graphical landing instruction for display on the display device 308 of the OWC 204.

In various embodiments, the landing instruction includes a graphical representation of a current state of at least one of an aircraft guidance panel, an aircraft throttle control, an aircraft flap control, an aircraft gear control, an aircraft trim control, an aircraft air/fuel mixture control, and an aircraft spoiler control and a graphical representation of a desired state of the at least one of the aircraft guidance panel, the aircraft throttle control, the aircraft flap control, the aircraft gear control, the aircraft trim control, the aircraft air/fuel mixture control, and the aircraft spoiler control. Implementation of the landing instruction results in placing the at least one of the aircraft guidance panel, the aircraft throttle control, the aircraft flap control, the aircraft gear control, the aircraft trim control, the aircraft air/fuel mixture control, and the aircraft spoiler control in the desired state.

Each landing instruction includes a sequence of landing instruction steps associated with implementation of an aircraft control function. In various embodiments, each of the sequence of landing instruction steps includes a graphical representation of a current state of at least one of an aircraft guidance panel, an aircraft throttle control, an aircraft flap control, an aircraft gear control, an aircraft trim control, an aircraft air/fuel mixture control, and an aircraft spoiler control and a graphical representation of a desired state of the at least one of the aircraft guidance panel, the aircraft throttle control, the aircraft flap control, the aircraft gear control, the aircraft trim control, the aircraft air/fuel mixture control, and the aircraft spoiler control. Implementation of a landing instruction step results in placing the at least one of the aircraft guidance panel, the aircraft throttle control, the aircraft flap control, the aircraft gear control, the aircraft trim control, the aircraft air/fuel mixture control, and the aircraft spoiler control in the desired state.

At 416, the interactive emergency landing assistance system 202 determines whether a pre-defined period of time has elapsed following receipt of the landing instruction without implementation of the landing instruction. If the interactive emergency landing assistance system 202 determines that the pre-defined period of time has elapsed following receipt of the landing instruction without implementation of the landing instruction at 416, the interactive emergency landing assistance system 202 generates instruction details associated with implementation of the landing instruction at 418. The instruction details include any additional information that enables the user to implement the landing instruction. In at least one embodiment, the instruction details indicate the reason for implementing the landing instruction. For example, the instruction detail may indicate that the implementation of the landing instruction adjusts a pitch of the aircraft 200. In at least one embodiment, the instruction details provides a location of an aircraft control that needs to be changed. In at least one embodiment, the instruction details detail how to adjust an aircraft control associated with implementation of a landing instruction. The method 400 proceeds to 420. If the interactive emergency landing assistance system 202 determines that the landing instruction has been implemented within the pre-defined period of time, the method proceeds to 420.

In various embodiments, when the landing instruction is a graphical landing instruction displayed on a display device 308 of the OWC 204, the interactive emergency landing assistance system 202 determines whether a cursor or pointer has been moved by the user over the graphical landing instruction and has been hovering over the graphical landing instruction for a pre-defined period of time. If the interactive emergency landing assistance system 202 determines that the cursor/pointer has been hovering over the landing instruction for a pre-defined period of time, the interactive emergency landing assistance system 202 generates the instruction details associated with the implementation of the graphical landing instruction for display on the display device based 308 of the OWC 204.

Each landing instruction includes a sequence of landing instruction steps. In various embodiments, when the landing instruction is a graphical landing instruction displayed on a display device 308 of the OWC 204, a graphical representation of the landing instruction steps are displayed on the display device 308 of the OWC 204. The interactive emergency landing assistance system 202 determines whether a cursor or pointer has been moved by the user over a graphical representation of a landing instruction step and has been hovering over the graphical representation of the landing instruction step for a pre-defined period of time. If the interactive emergency landing assistance system 202 determines that the cursor/pointer has been hovering over the graphical representation of the landing instruction step for a pre-defined period of time, the interactive emergency landing assistance system 202 generates the instruction details associated with the implementation of the landing instruction step for display on the display device based 308 of the OWC 204.

At 420, updated aircraft state data from the avionics systems 206 is transmitted to the ground station 210. The updated aircraft state data is generated following the implementation of the landing instruction. In various embodiments, the interactive emergency landing assistance system 202 receives the updated aircraft state data from the avionics systems 206 and transmits the received updated aircraft state data to the ground station 210. In at least one embodiment, the aircraft state data from the avionics systems 206 is transmitted to the ground station 210 on a continuous basis. In this case, the updated aircraft state data is transmitted as a part of the continuous transmission. In at least one embodiment, the aircraft state data from the avionics systems 206 is transmitted to the ground station 210 on a periodic basis. In this case, the updated aircraft state data is transmitted as a part of the periodic transmission.

At 422, the interactive emergency landing assistance system 202 determines whether the aircraft 200 has landed. If the interactive emergency landing assistance system 202 determines that the aircraft 200 has landed, the method 400 ends at 424.

If the interactive emergency landing assistance system 202 determines that the aircraft 200 has not landed, the method 400 returns to 414 and receives the next landing instruction from the ground station 210. The ground station 210 generates the next landing instruction based on the updated aircraft state data and transmits the next landing instruction to the interactive emergency landing assistance system 202 and the method repeats 416, 418, 420, and 422 until the interactive emergency landing assistance system 202 determines that the aircraft 200 has landed.

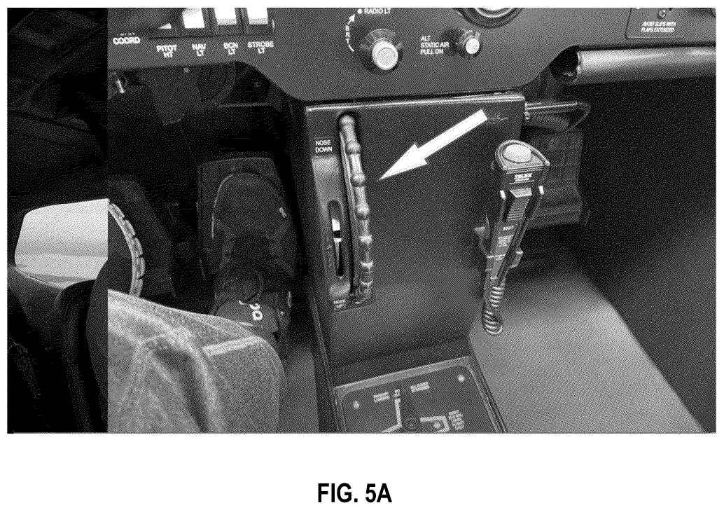

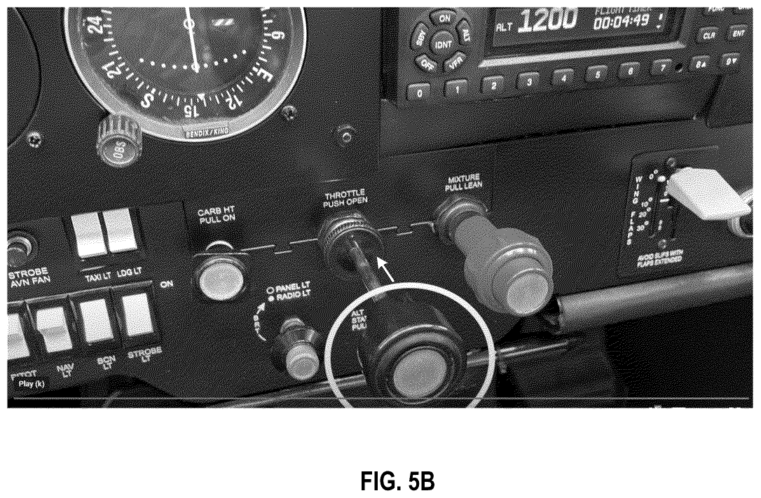

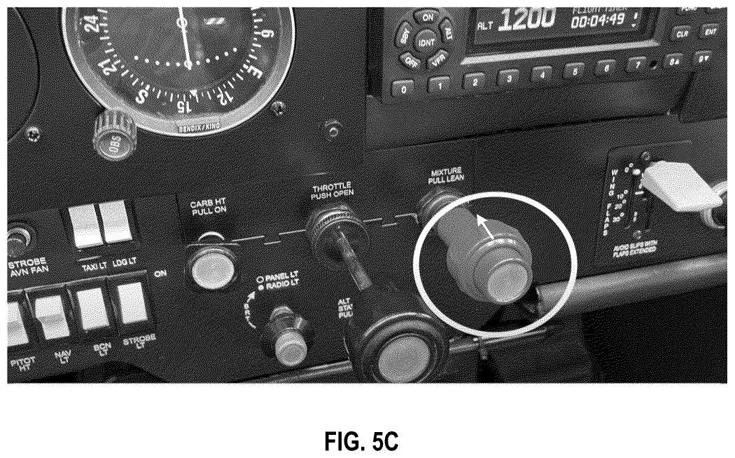

Referring to FIG. 5A-5C, diagrammatic representations of exemplary graphical landing instruction steps associated with a landing instruction in accordance with at least one embodiment are shown. The exemplary landing instruction includes three landing instruction steps. FIG. 5A is a graphical representation of the first landing instruction step. The first landing instruction step is directed to using an aircraft trim control to adjust the pitch of the aircraft 200. The current state (current position) of the aircraft trim control is shown. The arrow points to the desired state (desired position) of the aircraft trim control.

FIG. 5B is a graphical representation of the second landing instruction step. The second landing instruction step is directed to adjusting an aircraft throttle control. The circle identifies the location of the aircraft throttle control. The current state (current position) of the aircraft throttle control is shown. The arrow points to the desired state (desired position) of the aircraft throttle control.

FIG. 5C is a graphical representation of the third landing instruction step. The third landing instruction step is directed to adjusting the air/fuel mixture control. The circle identifies the location of the air/fuel mixture control. The current state (current position) of the air/fuel mixture control is shown. The arrow points to the desired state (desired position) of the air/fuel mixture control.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of providing interactive emergency landing assistance comprising:
receiving a pilot incapacitation indication at an interactive emergency landing assistance system;
receiving aircraft state data from at least one avionics system of an aircraft at the interactive emergency landing assistance system;
transmitting an emergency landing assistance request and the aircraft state data from the interactive emergency landing assistance system to a ground station;
receiving a first landing instruction from the ground station at the interactive emergency landing assistance system, the first landing instruction being based on the aircraft state data;
determining, by the interactive emergency landing assistance system, whether a first pre-defined period of time has elapsed following receipt of the first landing instruction without implementation of the first landing instruction;
generating, by the interactive emergency landing assistance system, instruction details associated with the implementation of the first landing instruction;
receiving updated aircraft state data from the at least one avionics system at the interactive emergency landing assistance system following the implementation of the first landing instruction;
transmitting the updated aircraft state data from the interactive emergency landing assistance system to the ground station; and
receiving a second landing instruction from the ground station at the interactive emergency landing assistance system, the second landing instruction being based on the updated aircraft state data.

2. The method of claim 1, wherein receiving the pilot incapacitation indication at the interactive emergency landing assistance system comprises receiving the pilot incapacitation indication from a pilot state monitoring system.

3. The method of claim 1, wherein receiving the pilot incapacitation indication at the interactive emergency landing assistance system comprises receiving a pilot incapacitation indication via a first user input.

4. The method of claim 1, further comprising:
generating an emergency landing assistance prompt, by the interactive emergency landing assistance system, responsive to receipt of the pilot incapacitation indication for display on a display device onboard the aircraft; and
activating the interactive emergency landing assistance system responsive to activation of the emergency landing assistance prompt via a second user input.

5. The method of claim 1, further comprising upon activation of the interactive emergency landing assistance system:
determining, by the interactive emergency landing assistance system, at least one of an aircraft type and an aircraft status of the aircraft; and
generating, by the interactive emergency landing assistance system, radio tuning instructions to tune a radio of the aircraft to the ground station, the ground station being associated with a nearest airport having a landing runway that is compatible with the at least one of the aircraft type and the aircraft status.

6. The method of claim 1, wherein:
receiving the first landing instruction from the ground station comprises receiving an audio first landing instruction for transmission via a speaker onboard the aircraft; and
receiving the second landing instruction from the ground station comprises receiving an audio second landing instruction for transmission via the speaker.

7. The method of claim 1, wherein:
receiving the first landing instruction from the ground station comprises receiving a graphical first landing instruction for display on a display device onboard the aircraft; and
receiving the second landing instruction from the ground station comprises receiving a graphical second landing instruction for display on the display device.

8. The method of claim 7, further comprising:
determining, by the interactive emergency landing assistance system, whether a cursor has been hovering over the first graphical landing instruction for a second pre-defined period of time; and
generating, by the interactive emergency landing assistance system, instruction details associated with the implementation of the first graphical landing instruction for display on the display device based on the determination.

9. The method of claim 7, wherein the graphical first landing instruction comprises a graphical representation of a current state of at least one of an aircraft guidance panel, an aircraft throttle control, an aircraft flap control, an aircraft gear control, an aircraft trim control, an aircraft air/fuel mixture control, and an aircraft spoiler control and a graphical representation of a first desired state of the at least one of the aircraft guidance panel, the aircraft throttle control, the aircraft flap control, the aircraft gear control, the aircraft trim control, the aircraft air/fuel mixture control, and the aircraft spoiler control.

10. The method of claim 9, wherein the graphical second landing instruction comprises a graphical representation of an updated state of the at least one of the aircraft guidance panel, the aircraft throttle control, the aircraft flap control, the aircraft gear control, the aircraft trim control, the aircraft air/fuel mixture control, and the aircraft spoiler control and a graphical representation of a second desired state of the at least one of the aircraft guidance panel, the aircraft throttle control, the aircraft flap control, the aircraft gear control, the aircraft trim control, the aircraft air/fuel mixture control, and the aircraft spoiler control.

11. The method of claim 1, further comprising generating, by the interactive emergency landing assistance system, user guidance phraseology associated with the emergency landing assistance request for transmission to an output device onboard the aircraft to enable a user to employ the user guidance phraseology to generate the emergency landing assistance request for transmission to the ground station.

12. The method of claim 1, wherein the ground station comprises at least one of air traffic control (ATC) and an airport operation center (AOC) service provider.

13. The method of claim 1 wherein the first landing instruction comprises a first sequence of landing instruction steps associated with implementation of an aircraft control function.

14. The method of claim 1, wherein a series of landing instructions associated with implementation of an emergency landing of the aircraft are received from the ground station at the interactive emergency landing assistance system, the series of landing instructions including the first and second landing instructions.

15. The method of claim 1, wherein an open world computer (OWC) comprises the interactive emergency landing assistance system.

16. A non-transitory machine-readable storage medium that stores instructions executable by at least one processor, the instructions configurable to cause the at least one processor to perform operations comprising:
receiving a pilot incapacitation indication at an interactive emergency landing assistance system;
receiving aircraft state data from at least one avionics system of an aircraft at the interactive emergency landing assistance system;
transmitting an emergency landing assistance request and the aircraft state data from the interactive emergency landing assistance system to a ground station;
receiving a first landing instruction from the ground station at the interactive emergency landing assistance system, the first landing instruction being based on the aircraft state data;
determining, by the interactive emergency landing assistance system, whether a first pre-defined period of time has elapsed following receipt of the first landing instruction without implementation of the first landing instruction;
generating, by the interactive emergency landing assistance system, instruction details associated with the implementation of the first landing instruction;
receiving updated aircraft state data from the at least one avionics system at the interactive emergency landing assistance system following the implementation of the first landing instruction;
transmitting the updated aircraft state data from the interactive emergency landing assistance system to the ground station; and
receiving a second landing instruction from the ground station at the interactive emergency landing assistance system, the second landing instruction being based on the updated aircraft state data.

17. The non-transitory machine-readable storage medium of claim 16, wherein the instructions are configurable to cause the at least one processor to further perform operations comprising:
determining, by the interactive emergency landing assistance system, at least one of an aircraft type and an aircraft status of the aircraft; and
generating, by the interactive emergency landing assistance system, radio tuning instructions to tune a radio of the aircraft to the ground station, the ground station being associated with a nearest airport having a landing runway that is compatible with the at least one of the aircraft type and the aircraft status.

18. The non-transitory machine-readable storage medium of claim 16, wherein the instructions are configurable to cause the at least one processor to further perform operations comprising:
receiving the first landing instruction from the ground station comprises receiving a graphical first landing instruction for display on a display device onboard the aircraft; and
receiving the second landing instruction from the ground station comprises receiving a graphical second landing instruction for display on the display device.

19. The non-transitory machine-readable storage medium of claim 18, wherein the instructions are configurable to cause the at least one processor to further perform operations comprising:
determining, by the interactive emergency landing assistance system, whether a cursor has been hovering over the first graphical landing instruction for a second pre-defined period of time; and
generating, by the interactive emergency landing assistance system, instruction details associated with the implementation of the first graphical landing instruction for display on the display device based on the determination.

20. The non-transitory machine-readable storage medium of claim 15, wherein the instructions are configurable to cause the at least one processor to further perform operations comprising:
generating, by the interactive emergency landing assistance system, user guidance phraseology associated with the emergency landing assistance request for transmission to an output device onboard the aircraft to enable a user to employ the user guidance phraseology to generate the emergency landing assistance request for transmission to the ground station.
